(19) United States
(12) Patent Application Publication
(10) Pub. No.: US 2012/0233286 A1
(43) Pub. Date: Sep. 13, 2012

(54) APPLICATION RUNNING DEVICE TO PERSONALIZE THE RUI

(75) Inventors: Jaime Chee, San Diego, CA (US); Stephane Lejuene, San Diego, CA (US); Steven Richman, San Diego, CA (US)

(73) Assignee: SONY CORPORATION, Tokyo (JP)

(21) Appl. No.: 13/042,157

(22) Filed: Mar. 7, 2011

(51) Int. Cl. G06F 15/16

(52) U.S. Cl. 709/217

(57) ABSTRACT

An application device generates a personalized remote user interface corresponding to a user. After the personalized remote user interface is sent to a rendering device, the personalized remote user interface displays a remote user interface related to the user.

### FIELD OF THE INVENTION

The present invention relates to the field of remote user interfaces. More specifically, the present invention relates to a device for personalizing a remote user interface.

### BACKGROUND OF THE INVENTION

The number of electronic devices in people's homes is continually increasing. Many years ago, homes only had a radio; then, a radio and a television. The number of devices has increased to the point where a typical home has several televisions, stereos, computers, video game consoles, mobile phones/devices, appliances and others. Furthermore, these devices are gaining intelligence so that they are able to communicate with each other.

The expansion of residential networks to include a multiplicity of devices that can share files asynchronously and connect to the Internet through residential gateways was facilitated by the de-facto standard use of wired and wireless ethernet connectivity. Asynchronous sharing then started to give way to buffered streaming of video as bandwidth availability improved. This was closely followed by real time streaming. Networks employ quality of service to manage bandwidth resource and Universal Plug and Play (UPnP) to perform discovery and compatibility of compressed video content. Video UPnP also defines remote user input operation like play, stop and rewind so that video control as well as video display is able to be performed remotely. Also, provisions were made to support graphical transfer of a remote user interface, but no implementations on the market have made use of this. UPnP allowed for many different standards of compressed video, but does not, however, certify that a client supported the relevant decoder. Digital Living Network Alliance (DLNA) is a standards body formed to provide certified device compatibility for a specific subset of UPnP implementations. It also defined the role of media servers, renderers, adapters, players and controllers.

A standard, referred to as Remote User Interface (RUI or Remote UI) is being developed to allow devices to operate each other and provide the user with a user interface that is configured appropriately for a device being used to control another device. For example, a user interface for a 46″ wide television is not likely to appear properly on a mobile phone which has a display of 2″. The Remote UI standard is a web-based protocol and framework for remote user interface on UPnP Networks and the Internet. The standard allows a UPnP-capable home network device to provide its interface (display and control options) as a web page to display on any other device coupled to the home network.

There are no well defined and widely accepted UPnP implementations for graphical RUI. One option, which has been backed by the UPnP Forum, is a browser based implementation known as CEA2014. The network client browser is considered to be heavy in flash, memory and/or processor requirements (‘thick’ client), whereas the network server application performs simple encapsulation of XML (‘thin’ server). In some situations this may be acceptable, like the case when rendering is performed by a personal computer and the application is run on a small mobile device, or a low end processing device, like a network router.

However, in the case of the home network where the rendering is done by a high definition TV, a Blu-Ray® player, a picture frame or a gaming machine, the use of a browser for RUI has some disadvantages. Firstly, a browser adds to the already substantial memory requirements of the renderers and so for these cost sensitive consumer electronics devices it may not be viable. Secondly, the processing speed requirements for a responsive experience are not going to be provided by the current range of devices available. And thirdly, the browser interface lends itself well to mouse and keyboard control, but is not necessarily the ideal format for a limited button remote control.

Also, the home network is able to include graphics applications built into game machines, video players, dongles and intelligent remotes on the low end, with cable boxes, cloud servers and multimedia PCs on the high end. To shoehorn all of these into one UPnP standard, it is clear that reach will be limited. In some cases substantial effort of rewriting or translation of the graphics application might be needed in order to fit the browser framework.

Another example of a proposed RUI is being provided through the RVU alliance. The RVU alliance was initiated by DirectTV in order to provide a pixel accurate remotely rendered version of their satellite decoder user interface. Unlike the browser based RUI, RVU uses a low level protocol that manipulates the graphics card framebuffer layers more directly. Instead of the script type messages that CEA2014 uses, RVU breaks up elements of the graphics into images that can be sent compressed or uncompressed over the network to be composited in the renderer's screen buffers or off screen buffers as needed. Simple bit commands are sent over the network to allow the images to be stretched, cut and alpha-blended on the renderer side. This type of RUI would be considered a thin network client and thick network server because most of the computation effort would be with the application. Also, because most actions involve sending image data, this type of RUI uses a lot of network resources.

The advantage of RVU is that the low level graphics operations are able to be supported by all graphics cards quite easily and is not directly dependent on the type of application to be able to function. However, sometimes performance is a key parameter in usability, and as such the network load and network server performance could severely limit how useful the protocol is. RVU is especially vulnerable where complete screen refreshes are needed often, like 3D rotations of a view. A browser approach could handle this more simply through scripts of simple rotation commands. Another similar limitation is when the application is providing remote graphics to multiple renderers, and causes the application processor to run short of the necessary MIPS to perform adequately.

### SUMMARY OF THE INVENTION

An application device generates a personalized remote user interface corresponding to a user. After the personalized remote user interface is sent to a rendering device, the personalized remote user interface displays a remote user interface related to the user.

In one aspect, a method of implementing a personalized remote user interface comprises recognizing a user, generating the personalized remote user interface and providing the personalized remote user interface to a rendering device. The recognizing is by a rendering device. The recognizing is by an application device. The recognizing further includes communicating presence information from the rendering device to an application device. The generating is by an application device. The method further comprises rendering the personalized remote user interface on the rendering device. The recognizing comprises at least one of biometric information, face recognition and device recognition. The application device is selected from the group consisting of a personal computer, a laptop computer, a computer workstation, a server, a mainframe computer, a handheld computer, a personal digital assistant, a cellular/mobile telephone, a smart appliance, a gaming console, a digital camera, a digital camcorder, a camera phone, an iPhone, an iPod®, a video player, a DVD writer/player, a television, a home entertainment system and an intelligent appliance.

In another aspect, a network of devices comprises an application device for generating a personalized remote user interface, a rendering device for rendering the personalized remote user interface and a network for operatively coupling the application device and the rendering device. The application device recognizes a user. The rendering device recognizes a user. The rendering device recognizes the user by at least one of biometric information, face recognition and device recognition. The rendering device is for communicating presence information to the application device.

In another aspect, a system programmed in a controller in a device comprises a generating module for generating a personalized remote user interface and a providing module for providing the personalized remote user interface to a rendering device. The system further comprises a recognizing module for recognizing a user. The recognizing comprises at least one of biometric information, face recognition and device recognition. The controller is selected from the group consisting of a programmed computer readable medium and an application-specific circuit.

In another aspect, an application device comprises a memory for storing an application, the application for generating a personalized remote user interface and providing the personalized remote user interface to a rendering device and a processing component coupled to the memory, the processing component for processing the application. The application is further for recognizing a user. The recognizing comprises at least one of biometric information, face recognition and device recognition.

### BRIEF DESCRIPTION OF THE DRAWINGS

FIG. 1 illustrates a block diagram of a network of devices implementing a method of personalizing an RUI using an application device according to some embodiments.

FIG. 2 illustrates a flowchart of a method of utilizing an application device to personalize an RUI according to some embodiments.

FIG. 3 illustrates a block diagram of an exemplary computing device to personalize an RUI according to some embodiments.

### DETAILED DESCRIPTION OF THE PREFERRED EMBODIMENT

A method of an application running device personalizing a Remote User Interface (Remote UI or RUI) is described herein. The personalized RUI is generated by receiving presence information from a rendering device revealing the presence of one or more users and generating from that revealed information a new and more personalized RUI. Using this method, a user's experience in operating a device is made easier and simpler as the options presented to the user better fit their needs.

A rendering device announces its presence and is able to receive an RUI. An application device announces its presence, recognizes other devices and analyzes their abilities to generate a tailored RUI.

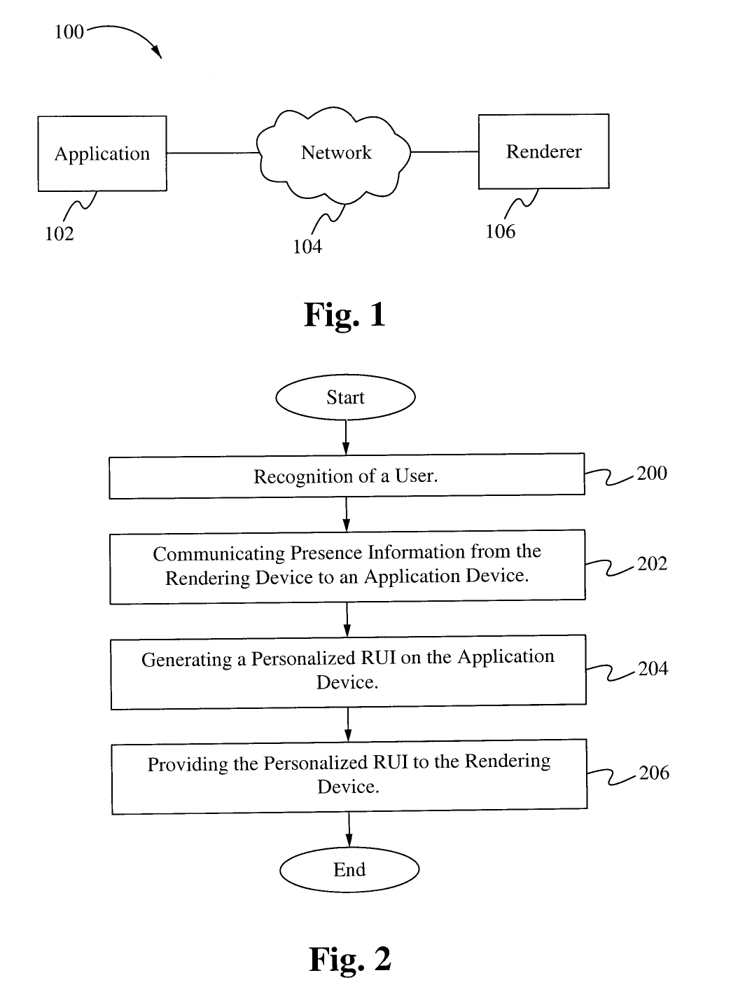

FIG. 1 illustrates a block diagram of a network of devices implementing a method of personalizing an RUI using an application device according to some embodiments. The network of devices 100 includes one or more gateway or application devices 102 coupled through a network 104 with a renderer (e.g. a television) 106. In some embodiments, the application device 102 and the renderer 106 are coupled directly, and in some embodiments, the application device 102 and the renderer 106 are coupled through the network 104. The network 104 is able to be any type of network including, but not limited to, a LAN, a WAN, the Internet, a cellular network, a wireless network, a wired network and/or any combination thereof.

The application device 102 is any device that sends RUI data such as RUI commands to a renderer 106. The application device 102 is able to announce its presence. The application device 102 also recognizes other devices and analyzes their abilities to generate a tailored RUI.

The application device 102 receives presence information from the rendering device 106 including the presence of one or more users and extracts that information. In some embodiments, the user presence information is stored on the renderer 106, the application device 102 or both.

The renderer 106 is any device that is able to render and display the RUI data, for example, a television displaying an RUI. The rendering device 106 is able to announce its presence.

For example, in operation, the application device 102 discovers or is discovered by a renderer 106. The application device 102 also contains or retrieves user information from the renderer 106. The application device 102 then utilizes the user information to personalize the RUI which is then sent to and displayed on the renderer 106. The personalized RUI is able to include features specific to the user such as a border specific to the user, saved channels specific to the user and other user-specific features.

FIG. 2 illustrates a flowchart of a method of utilizing an application device to personalize an RUI according to some embodiments. In the step 200, a user is recognized by a rendering device. The user is recognized using any mechanism including, but not limited to, biometric information such as face recognition, device recognition (e.g. Bluetooth®) and others. In some embodiments, the user is recognized by the application device. In the step 202, presence information is communicated from the rendering device to an application device. If the user is recognized by the application device, the step 202 is able to be skipped. In the step 204, a personalized RUI is generated on the application device. In the step 206, the personalized RUI is provided to the rendering device. Additional steps are able to be included such as discovering an application device and/or a rendering device. In some embodiments, the application device and/or the rendering device announces its presence. In some embodiments, the rendering device renders (e.g. displays) the personalized RUI. In some embodiments, a user logs into the application device and/or the rendering device, and the logging in identifies the user. Although specific steps are described, in some embodiments, fewer or more steps are included, and/or the order of the steps is able to be changed.

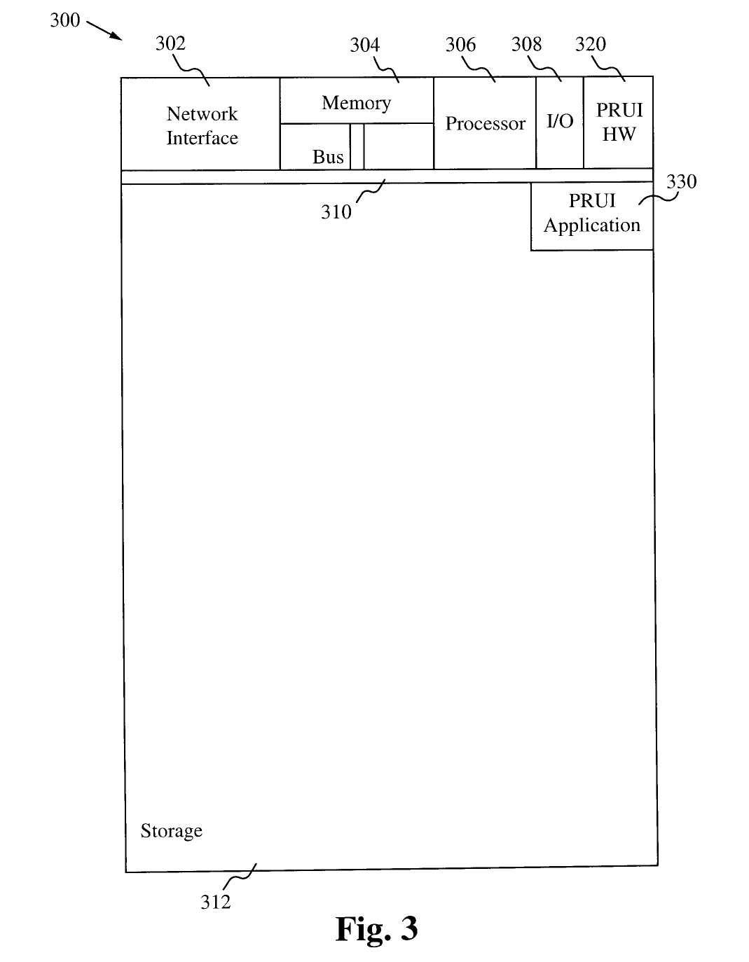

FIG. 3 illustrates a block diagram of an exemplary computing device 300 to personalize an RUI according to some embodiments. The computing device 300 is able to be used to acquire, store, compute, communicate and/or display information. For example, the computing device 300 is able to receive, generate, store, and personalize an RUI. In general, a hardware structure suitable for implementing the computing device 300 includes a network interface 302, a memory 304, a processor 306, I/O device(s) 308, a bus 310 and a storage device 312. The choice of processor is not critical as long as a suitable processor with sufficient speed is chosen. The memory 304 is able to be any conventional computer memory known in the art. The storage device 312 is able to include a hard drive, CDROM, CDRW, DVD, DVDRW, Blu-ray®, flash memory card or any other storage device. The computing device 300 is able to include one or more network interfaces 302. An example of a network interface includes a network card connected to an Ethernet or other type of LAN. The I/O device(s) 308 are able to include one or more of the following: keyboard, mouse, monitor, display, printer, modem, touchscreen, button interface and other devices. Personalizing RUI application(s) 330 used to perform the personalizing RUI method are likely to be stored in the storage device 312 and memory 304 and processed as applications are typically processed. More or less components shown in FIG. 3 are able to be included in the computing device 300. In some embodiments, personalizing RUI hardware 320 is included. Although the computing device 300 in FIG. 3 includes applications 330 and hardware 320, the personalizing RUI method is able to be implemented on a computing device in hardware, firmware, software or any combination thereof. For example, in some embodiments, the personalizing RUI applications 330 are programmed in a memory and executed using a processor. In another example, in some embodiments, the personalizing hardware 320 is programmed hardware logic including gates specifically designed to implement the personalizing RUI method.

In some embodiments, the personalizing RUI application(s) 330 include several applications and/or modules. As described herein, the modules are able to include a generating module for generating a personalized RUI and a providing module for providing the personalized RUI to the rendering device. In some devices there are other modules, such as a recognition module for recognizing a user and a communicating module for communicating presence information to an application device. In some embodiments, modules include one or more sub-modules as well. In some embodiments, fewer or additional modules are able to be included.

Examples of suitable computing devices for the server device, source device and rendering device include a personal computer, a laptop computer, a computer workstation, a server, a mainframe computer, a handheld computer, a personal digital assistant, a cellular/mobile telephone, a smart appliance, a gaming console, a digital camera, a digital camcorder, a camera phone, an iPod®/iPhone, a video player, a DVD writer/player, a Blu-ray® writer/player, a television, a home entertainment system or any other suitable computing device. In some embodiments, a computing device is able to include intelligent appliances such as a refrigerator, a toaster, a toaster oven and a microwave, where the appliances are able to process and/or present information.

To utilize the method of personalizing an RUI, a user utilizes an application device such as a mobile device as a remote control for a television similarly to the standard use of such a device. However, the user is presented with a personalized RUI on the television instead of a generic RUI. With the personalized RUI, the user is able to enjoy a more personalized experience, such as personalized menus, than with a generic RUI.

In operation, a user is recognized and the user's presence is utilized by an application device to generate a personalized RUI which is displayed on a rendering device. By recognizing a user, generating the personalized RUI and displaying the personalized RUI, a user has a better experience with the rendering device. The personalized RUI is able to make navigating on the rendering device easier, provide varying appearances to the rendering device and any other modification to the rendering device.

The devices implemented within the network described herein are able to implement Digital Living Network Alliance (DLNA) standard as well.

### Some Embodiments of an Application Running Device to Personalize the RUI

1. A method of implementing a personalized remote user interface comprising:
   a. recognizing a user;
   b. generating the personalized remote user interface; and
   c. providing the personalized remote user interface to a rendering device.
2. The method of clause 1 wherein the recognizing is by a rendering device.
3. The method of clause 1 wherein the recognizing is by an application device.
4. The method of clause 1 wherein the recognizing further includes communicating presence information from the rendering device to an application device.
5. The method of clause 1 wherein the generating is by an application device.
6. The method of clause 1 further comprising rendering the personalized remote user interface on the rendering device.
7. The method of clause 1 wherein the recognizing comprises at least one of biometric information, face recognition and device recognition.
8. The method of clause 1 wherein the application device is selected from the group consisting of a personal computer, a laptop computer, a computer workstation, a server, a mainframe computer, a handheld computer, a personal digital assistant, a cellular/mobile telephone, a smart appliance, a gaming console, a digital camera, a digital camcorder, a camera phone, an iPhone, an iPod®, a video player, a DVD writer/player, a television, a home entertainment system and an intelligent appliance.
9. A network of devices comprising:
   a. an application device for generating a personalized remote user interface;
   b. a rendering device for rendering the personalized remote user interface; and
   c. a network for operatively coupling the application device and the rendering device.
10. The network of devices of clause 9 wherein the application device recognizes a user.
11. The network of devices of clause 9 wherein the rendering device recognizes a user.
12. The network of devices of clause 11 wherein the rendering device recognizes the user by at least one of biometric information, face recognition and device recognition.
13. The network of devices of clause 9 wherein the rendering device is for communicating presence information to the application device.
14. A system programmed in a controller in a device comprising:
   a. a generating module for generating a personalized remote user interface; and
   b. a providing module for providing the personalized remote user interface to a rendering device.
15. The system of clause 14 further comprising a recognizing module for recognizing a user.
16. The system of clause 15 wherein the recognizing comprises at least one of biometric information, face recognition and device recognition.
17. The system of clause 14 wherein the controller is selected from the group consisting of a programmed computer readable medium and an application-specific circuit.
18. An application device comprising:
   a. a memory for storing an application, the application for:
      i. generating a personalized remote user interface; and
      ii. providing the personalized remote user interface to a rendering device; and
   b. a processing component coupled to the memory, the processing component for processing the application.
19. The application device of clause 18 wherein the application is further for recognizing a user.
20. The application device of clause 19 wherein the recognizing comprises at least one of biometric information, face recognition and device recognition.

The present invention has been described in terms of specific embodiments incorporating details to facilitate the understanding of principles of construction and operation of the invention. Such reference herein to specific embodiments and details thereof is not intended to limit the scope of the claims appended hereto. It will be readily apparent to one skilled in the art that other various modifications may be made in the embodiment chosen for illustration without departing from the spirit and scope of the invention as defined by the claims.

What is claimed is:

1. A method of implementing a personalized remote user interface comprising:
a. recognizing a user;
b. generating the personalized remote user interface; and
c. providing the personalized remote user interface to a rendering device.

2. The method of claim 1 wherein the recognizing is by a rendering device.

3. The method of claim 1 wherein the recognizing is by an application device.

4. The method of claim 1 wherein the recognizing further includes communicating presence information from the rendering device to an application device.

5. The method of claim 1 wherein the generating is by an application device.

6. The method of claim 1 further comprising rendering the personalized remote user interface on the rendering device.

7. The method of claim 1 wherein the recognizing comprises at least one of biometric information, face recognition and device recognition.

8. The method of claim 1 wherein the application device is selected from the group consisting of a personal computer, a laptop computer, a computer workstation, a server, a mainframe computer, a handheld computer, a personal digital assistant, a cellular/mobile telephone, a smart appliance, a gaming console, a digital camera, a digital camcorder, a camera phone, an iPhone, an iPod®, a video player, a DVD writer/player, a television, a home entertainment system and an intelligent appliance.

9. A network of devices comprising:
a. an application device for generating a personalized remote user interface;
b. a rendering device for rendering the personalized remote user interface; and
c. a network for operatively coupling the application device and the rendering device.

10. The network of devices of claim 9 wherein the application device recognizes a user.

11. The network of devices of claim 9 wherein the rendering device recognizes a user.

12. The network of devices of claim 11 wherein the rendering device recognizes the user by at least one of biometric information, face recognition and device recognition.

13. The network of devices of claim 9 wherein the rendering device is for communicating presence information to the application device.

14. A system programmed in a controller in a device comprising:
a. a generating module for generating a personalized remote user interface; and
b. a providing module for providing the personalized remote user interface to a rendering device.

15. The system of claim 14 further comprising a recognizing module for recognizing a user.

16. The system of claim 15 wherein the recognizing comprises at least one of biometric information, face recognition and device recognition.

17. The system of claim 14 wherein the controller is selected from the group consisting of a programmed computer readable medium and an application-specific circuit.

18. An application device comprising:
a. a memory for storing an application, the application for:
i. generating a personalized remote user interface; and
ii. providing the personalized remote user interface to a rendering device; and
b. a processing component coupled to the memory, the processing component for processing the application.

19. The application device of claim 18 wherein the application is further for recognizing a user.

20. The application device of claim 19 wherein the recognizing comprises at least one of biometric information, face recognition and device recognition.
